(19) United States
(12) Patent Application Publication
(10) Pub. No.: US 2008/0018632 A1
(43) Pub. Date: Jan. 24, 2008

(54) Driving To Reduce Aging In An Active Matrix Led Display

(75) Inventors: Claus Nico Cordes, Eindhoven (NL); Frank Budzelaar, Eindhoven (NL); Ingrid Maria Laurentia Cornelia Vogels, Eindhoven (NL); Jurgen Hoppenbrouwers, Eindhoven (NL); Michiel Adriaanszoon Klompenhouwer, Eindhoven (NL); Nijs Cornelis Van Der Vaart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,541

(22) PCT Filed: Jun. 13, 2005
(86) PCT No.: PCT/IB05/51939

§ 371 Date: Dec. 13, 2006

(30) Foreign Application Priority Data
Jun. 22, 2004 (EP) 04102860.6

(51) Int. Cl. G09G 3/32

(52) U.S. Cl. 345/208

(57) ABSTRACT

A driver (DD, SD, PD1, PS1, PD2, PS2) supplies, at a frame rate, a first current (I1) with a first duty cycle being smaller than one to a first light emitting element (PL1) of an active matrix display (AMD) and a second current (I2) to a second light emitting element (PL2) of the active matrix display (AMD). The second light emitting element (PL2) has a shorter lifetime than the first light emitting element (PL1). The driver (DD, SD, PD1, PS1, PD2, PS2) limits controls the second duty cycle to be larger than the first duty cycle.

### FIELD OF THE INVENTION

The invention relates to a driver for an active matrix display, a display module comprising an active matrix display and such a driver, a display apparatus comprising the display module, and a method of driving an active matrix display.

### BACKGROUND OF THE INVENTION

U.S. Pat. No. 6,583,775 B1 discloses an active matrix display of which the pixels comprise light emitting elements which have a brightness level depending on an amount of current supplied to the light emitting elements. The light emitting elements are OLED's (organic light emitting diodes). A scanning line drive circuit selects the rows of pixels one by one, each one during a row select period. A data line drive circuit supplies data signals in parallel to the row of selected pixels. The pixels comprise a pixel drive circuit which determines a level of the current dependent on the data received. At the start of a row select period, the light emitting elements start to emit with a brightness determined by the current. After the row select period, the light emitting elements continue emitting with this brightness, usually until after a scanning period or frame period the same row of pixels is selected again and new data signals are received.

U.S. Pat. No. 6,583,775 B1 discloses that the pixel drive circuit further comprises an input to receive a stop signal via a stopping control line. The occurrence of the stopping signal causes the associated light emitting elements of a row to stop emitting light at an instant before this row is selected again. The duty cycle indicates the ratio between the on-time of the pixels and the frame period. By adjusting the duty cycle of all the pixels, the display brightness can be adjusted. It is disclosed that it is even more significant that the duty cycle can be made smaller than 1, for example to 1/10, for all the pixels to increase the peak current and to decrease the channel length of the thin film transistor in the active matrix included in each pixel. In this manner, by suitably selecting the duty cycle, the degree of freedom of designing the thin film transistors increases.

In a color display in which red, green and blue pixels are present, all the red pixels of a row are connected to a same one of the stopping control lines, all the green pixels are connected to another one of the stopping control lines, and all the blue pixels are connected to yet another one of the stopping control lines. The light emitting of pixels which have different colors can be stopped at different instants. These different stop instants are used to control the color balance in a simple way.

Further, it is disclosed that a reduction of motion blur can be reached by setting the duty cycle to about 50% or, preferably to 25% or less.

However the smaller the ratio between the on-time of the pixels and the frame period becomes, the larger the current through the light emitting elements has to become to obtain the same luminance. These high currents cause the light emitting elements to age faster due to the non-linearity of the aging function. The ratio is also referred to as the duty cycle.

### SUMMARY OF THE INVENTION

It is an object of the invention to provide a driver for an active matrix display in which the aging of the light emitting elements which emit light with a different color is more equal.

A first aspect of the invention provides a driver as claimed in claim 1. A second aspect of the invention provides a display module as claimed in claim 7. A third aspect of the invention provides a display apparatus as claimed in claim 11. A fourth aspect of the invention provides method of driving an active matrix display as claimed in claim 12. Advantageous embodiments are defined in the dependent claims.

The driver in accordance with the first aspect supplies a first current to a first light emitting element of the active matrix display and a second current to a second light emitting element of the active matrix display. Because the data is refreshed at a frame rate, also these currents occur at a frame rate. The second light emitting element ages faster than the first light emitting element at a particular luminance output if the same duty cycle is used. The driver selects the duty cycle of the second light emitting element at a higher value than the duty cycle of the first light emitting element. This limits the second current to a relatively lower maximum value than when the duty cycle of the second light element would be equal to the duty cycle of the first light emitting element. Consequently, a too fast aging of the second light emitting element is prevented by limiting the current through it. On the other hand, because the duty cycle of the first light emitting element is smaller than one, the motion blur will decrease.

U.S. Pat. No. 6,583,775 B1 discloses that a brightness control, a motion blur decrease, and a higher freedom to design the thin film transistor requires that the duty cycle of all the pixels has to be made shorter than one. In a special embodiment, the duty cycle of different colored pixels may be different to control the color balance. But, this prior art fails to disclose and to teach that the duty cycle of the faster aging pixels (which have a second color) is controlled to be larger than the duty cycle of the slower aging pixels (which have a first color). These are not related issues; the color balance setting is determined by the desired displayed white point of the display. This could be determined by for example the efficiencies of the different colored materials or the preference of the viewer. The aging speed is determined by the aging properties of the different colored materials.

In the embodiment as claimed in claim 2, the maximum value of the current through the fastest aging light emitting element is limited with respect to the maximum value of the current through the slowest aging light emitting element by limiting the minimum duty cycle of the fastest aging light emitting element to a higher value than the minimum duty cycle of the slowest aging light emitting element. Because of the longer duty cycle available for the fastest aging light emitting element, the maximum current through this element will be limited to a lower value, and thus its aging will be slowed down. Consequently, the aging of the different light emitting elements will become more equal. This is due to the fact that the lifetime LT of polymer materials depends on the time T a luminance LU is generated is given in the next equation: LT˜LU^{-p}/T, wherein p is a power factor which depends on the material properties. The invention can be used for all light emitting elements that exhibit the above described behavior with a factor p larger than 1. Small molecule OLED as well as polymer OLED materials are known with such behavior. The publication “Technology and materials for full-color polymer light-emitting displays” by Simone I. E. Vulto et al, Proceedings of the SPIE, Volume 5214-6, 2003, discusses the aging behavior of the polymer material.

In the embodiment in accordance with the invention as claimed in claim 3, the first time period during which the slowest aging light emitting element is emitting light is selected to be equal or shorter than half the frame period (the duty cycle is equal or smaller than 0.5) to decrease the motion blur to an acceptable level. However, to prevent the fastest aging light emitting element to age too fast, it is driven with a duty cycle larger than 0.5. Consequently, because the same light output of this fastest aging light emitting element has to be obtained, the level of the current through this fastest aging light emitting element is correspondingly decreased.

Although one of the light emitting elements is driven with a relatively large duty cycle with respect to the other one, the other one is driven with a relatively small duty cycle and the overall motion blur decreases. This is especially the case if the fastest aging light emitting element has a color which has the lowest contribution to the luminance of the pixel or of which the effect on the motion blur is lowest.

In practical implementations of a color display, three different light emitting elements may be present which emit the colors red, green and blue. In OLED displays, usually the light emitting element emitting blue light has the shortest lifetime. The visibility of the motion blur is hardly influenced by selecting the duty cycle of the blue light emitting element to be longer than the duty cycle of the red and green light emitting elements because blue has a relatively small contribution to luminance.

In the embodiment in accordance with the invention as claimed in claim 4, the duty cycle of the fastest aging light emitting element is selected to be substantially 1 to obtain the lowest current possible through this light emitting element such that its lifetime is maximal. The duty cycle of the slowest aging light emitting element is selected smaller than 1 to decrease the motion blur.

In the embodiment in accordance with the invention as claimed in claim 5, if the duty cycle is smaller than one, the period in time the light emitting element is emitting light is centered within the frame period to minimize the color break-up effect, if an address and flash addressing scheme is used: all pixels of one color are on or off at the same time. Another option is a system wherein the rows are addressed one by one and give light sequentially. In that case, the light generation periods are now center aligned with respect to each other per row.

In the embodiment in accordance with the invention as claimed in claim 6, the currents through the light emitting elements are determined by data signals corresponding to the image to be displayed. The different duty cycles for the light emitting elements which have different lifetimes are selected to have different fixed values per frame period. The different fixed values per frame period may depend, for example, on the average image content to perform power limiting. In this case, the ratio between the duty cycles of the different colors is fixed. The ratio between the duty cycles ofthe fastest aging pixels and the other pixels should be as large as possible, regardless of other duty cycle control mechanisms. This means that the duty cycle of the fastest aging pixels is as large as possible, usually, one, while the duty cycle of the other colored pixels is as small as possible to obtain an as large as possible decrease of the visibility of the motion blur. The ratio between the light output (duty cycle multiplied by current) of the different colored pixels should be fixed to obtain the desired white point. The maximum current for each color then automatically follows from the duty cycle selected or vice versa

Preferably, the light emitting elements are organic light emitting diodes (OLED's). Preferably, the different light emitting elements emit light with different colors.

These and other aspects of the invention are apparent from and will be elucidated with reference to the embodiments described hereinafter.

### BRIEF DESCRIPTION OF THE DRAWINGS

In the drawings:

FIG. 1 shows a schematically view of part of an active matrix display apparatus,

FIG. 2 shows signals occurring in the active matrix display apparatus,

FIG. 3 shows an embodiment of a drive circuit of a pixel, and

FIG. 4 elucidates the effect of centering the drive pulses with respect to the frame period.

### DETAILED DESCRIPTION OF THE PREFERRED EMBODIMENT

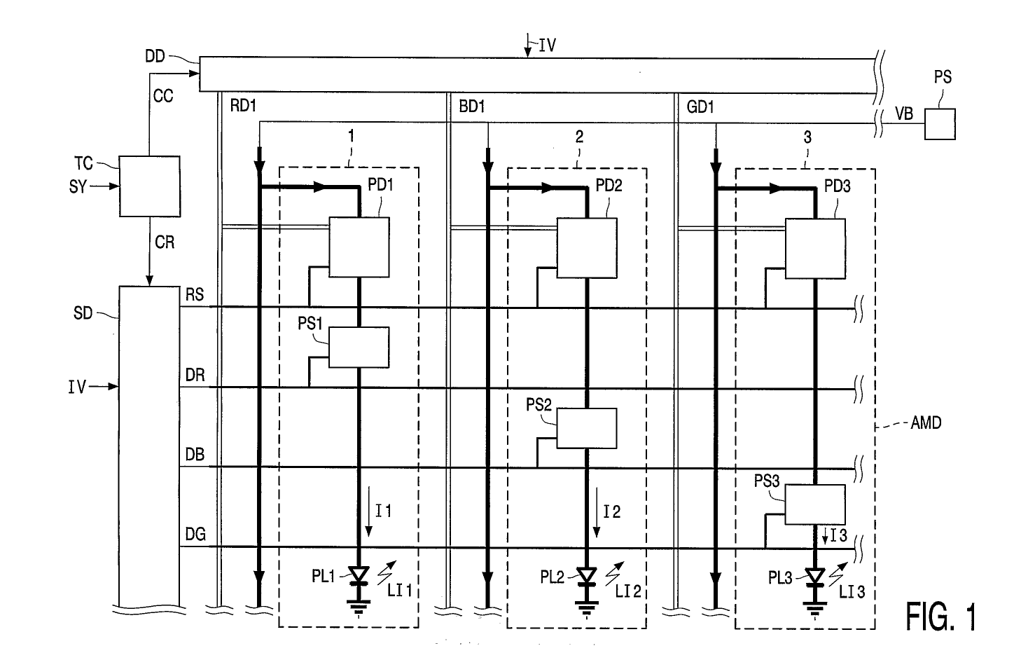

FIG. 1 shows a schematically view of an active matrix display apparatus. The active matrix display AMD shown only comprises three pixels 1, 2, and 3. In a practical embodiment, the matrix display comprises many more pixels.

Each pixel 1, 2, and 3 comprises a series arrangement of a pixel driving circuit PD1, PD2, and PD3 which are collectively referred to as PDi, a pixel switch circuit PS1, PS2, and PS3 which are collectively referred to as PSi, a light emitting element PL1, PL2, and PL3 which are collectively referred to as PLi and which emit light LI1, LI2, and LI3, respectively. Each one of the pixel driving circuits PDi comprises an input to receive a power supply voltage VB, an input to receive a data signal Di (RD1, BD1, and GD1, respectively for the pixels 1, 2, 3 shown), an input to receive a row select signal RS, and an output to supply a current to the associated pixel switch circuit PSi. The pixels 1, 2, 3 are collectively referred to as Pi.

Each one of the pixel switch circuits PSi receives the current from the associated pixel driving circuit PDi and a duty cycle signal DCi (DR, DB, and DG, respectively for the pixels Pi shown) and supplies the current Ii (I1, I2, and I3, respectively for the pixels Pi shown) to the associated light emitting element PLi. The current Ii is supplied to the light emitting element PLi with a duty cycle in accordance with the duty cycle signal DCi. The duty cycle is defined as the ratio of the on-time of the light emitting element PLi during a frame period Tf and the duration of the frame period Tf.

The power supply voltage VB is supplied by a power supply PS. The same power supply voltage VB may be supplied to all the pixels Pi. The select driver SD receives a control signal CR and supplies the row select signal RS. Usually, the row select signals RS (only one is shown) are activated one by one to select the rows of pixels Pi one by one. The data driver DD receives a control signal CC and the input image signal IV and supplies the data signals Di in parallel to the row of selected pixels Pi. The timing circuit TC receives the synchronization information SY associated with the input image signal IV and supplies the control signals CC and CR to synchronize the select driver SD and the data driver DD with respect to each other and with respect to the input image signal IV. FIG. 1 shows that the select driver SD further supplies the duty cycle signals DCi. If the duty cycles are fixed this is possible in a simple way. If the duty cycles are variable, the select driver SD requires information on the input signal IV. Instead of the input signal IV, the select driver SD may receive the duty cycle information from the data driver DD. Alternatively, the duty cycle signals DCi may be supplied by the data driver DD instead of the select driver SD.

The light emitting elements PLi may be any elements which generate light with a luminance LIi dependent on the current Ii flowing through it. For example, the light emitting elements PLi may be organic light emitting diodes further referred to as OLED's. A high peak luminance of such an OLED and consequently a high current Ii through the OLED may dramatically shorten its lifetime due to non-linear degradation effects. As such, long duty cycles are preferred because a relatively low associated peak current is required to obtain a particular desired luminance. However, long duty cycles cause motion blur artifacts. A light emitting element PLi ages faster than another light emitting element if the decay of its luminance is larger after a same time period during which the same current is supplied.

For current OLED displays, the lifetime of the different OLED's which emit different colors light is different. Especially, the life time of the blue OLED's is significantly shorter than that of the red and green OLED's. A compromise between the lifetime and the motion blur artifacts is possible by reducing the duty cycle of the red and the green OLED's, while the duty cycle of the blue OLED is kept relatively large. In this compromise, a significant reduction of the motion blur is achieved as the blue light contributes little to the sharpness impression of the image, while at the same time the aging of the blue OLED is minimized.

The active matrix display AMD is often referred to as display panel which is defined to comprise the pixels Pi. In a practical embodiment, the display panel AMD may also comprise all or some of the driver circuits DD, SD and TC. This combination of driver circuits DD, SD and TC and display panel 1 is often referred to as display module. This display module can be used in many display apparatuses, for example in television, computer display apparatuses, game consoles, or in mobile apparatuses such as PDA's (personal digital assistant) or mobile phones.

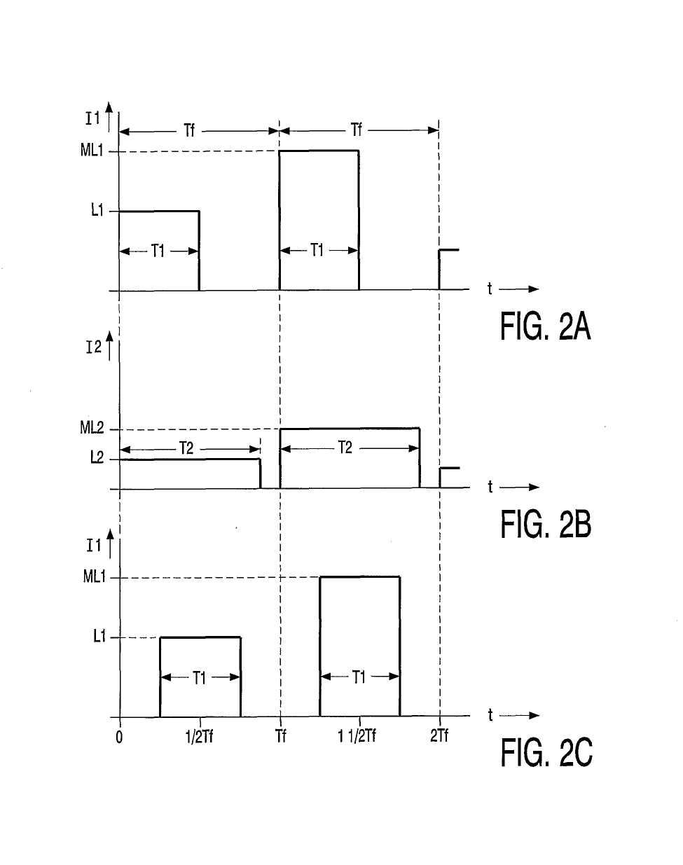

FIG. 2 shows signals occurring in the active matrix display apparatus. FIGS. 2A and 2C show the current I1 supplied to the light emitting element PL1. FIG. 2B shows the current I2 supplied to the light emitting element PL2 which ages faster than the light emitting element PL1.

FIG. 2A shows that the current I1 through the light emitting element PL1 has, by way of example, a duty cycle of 0.5. The on-time T1 of the light emitting element has a duration of half the frame period Tf. During the first frame period Tf lasting from the instant 0 to the instant Tf the current I1 has a level L1 lower than the maximum level ML1. During the second frame period Tf lasting from the instant Tf to the instant 2Tf, the current I1 has its maximum level ML1.

FIG. 2B shows that the current I2 through the light emitting element PL1 has, by way of example, a duty cycle near to one. The on-time T2 of the light emitting element PL2 has a duration of almost the frame period Tf. During the first frame period Tf lasting from the instant 0 to the instant Tf the current I2 has a level L2 lower than the maximum level ML2. During the second frame period Tf lasting from the instant Tf to the instant 2Tf, the current I2 has the maximum level ML2 which is lower than the maximum level ML1 (of the other pixels). Consequently, because the maximum level ML2 through the fastest aging light emitting element PL2 is lower than the maximum level ML1 through the slowest aging light emitting element PL1, the actual lifetime of the fastest aging light emitting element PL2 and the entire display system is increased. In a preferred embodiment, the limiting of the maximum level ML1 to a lower value than the maximum level ML2 is obtained by limiting the minimum value of the duty cycle of the current I2 to a higher value than the minimum value of the duty cycle of the current I1. Or said differently, by limiting the minimum duration of the period in time T2 during which the fastest aging light emitting element PL2 emits light to a value larger than the minimal duration of the period in time T1 during which the slowest aging light emitting element PL1 emits light.

FIG. 2C shows the same pulses as shown in FIG. 2A but now centered with respect to the center 1/2Tf, 3/2 Tf, respectively, of the frame periods Tf to decrease the color break up artifact. If the rows of pixels are addressed sequentially and emit light sequentially, the on-periods of the different colored pixels should be centered with respect to the pixels in the same row.

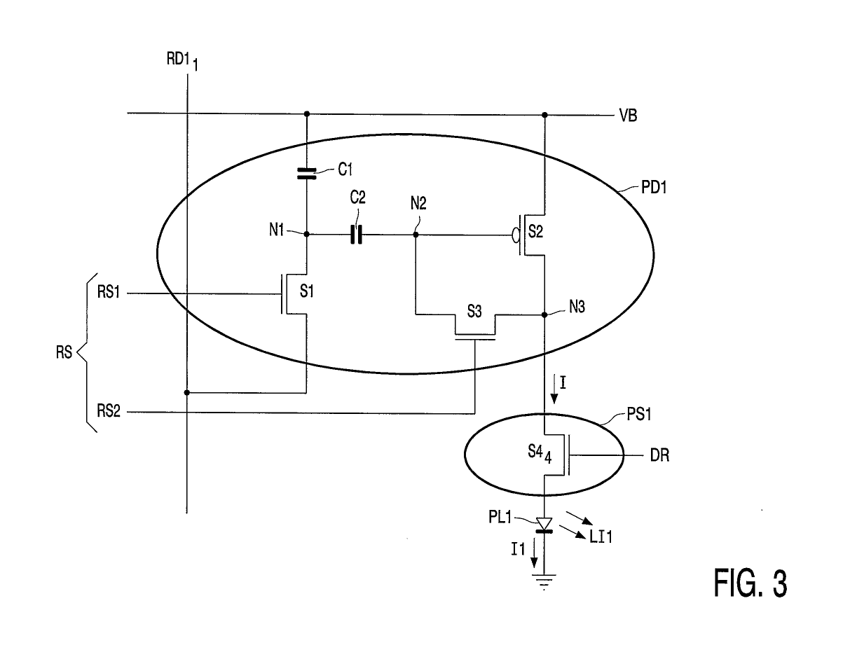

FIG. 3 shows an embodiment of a drive circuit of a pixel. By way of example, the detailed construction of the pixel 1 is shown. The other pixels have in principle the same structure.

The pixel driving circuit PD1 comprises a first transistor S1 with a control electrode coupled to receive a first row select signal RS1, and a main current path coupled between a data line and a node N1. The data line caries the data signal RD1. A capacitor C1 is arranged between the node N1 and a power supply line carrying the power supply voltage VB. A capacitor C2 is arranged between the node N1 and a node N2. A transistor S2 has a control electrode coupled to the node N2 and a main current path arranged between the power supply line and a node N3. A transistor S3 has a control electrode coupled to receive a second row select signal RS2 and a main current path arranged between the nodes N2 and N3.

The pixel switch circuit PS1 comprises a transistor S4 which has a control input coupled to receive the duty cycle signal DR and a main current path arranged between the node N3 which is the output of the pixel driving circuit PD1 and the anode of the OLED PL1. The cathode of the OLED PL1 is coupled to ground.

The operation of the drive circuits of the pixel is elucidated in the now following. It is assumed that the transistors S1 to S4 are MOSFET'S. In the starting situation, both the row select signals RS1 and RS2 and the duty cycle signal DR have a high level and consequently the transistors S1, S3 and S4 are conductive. The data signal RD1 has a well defined reference voltage level. The current I1 flows through the light emitting element PL1. Because this phase has a very short duration, for example 1 to 2 microseconds, the amount of light generated is negligible. Next, the duty cycle signal DR goes to a low level and the transistor S4 stops conducting the current I1. The current I1 then flows via the gate electrode of the transistor S2 to the data line until the gate-source voltage of transistor S2 is equal to its threshold voltage and the transistor S2 stops conducting. Due to the conducting transistors S1 and S3 and the reference data voltage RD1, this threshold voltage is stored in the capacitor C2.

Now an addressing step follows wherein the row select signal RS1 has a high level and the row select signal RS2 and the duty cycle signal have a low level. With respect to the previous phase wherein the threshold voltage is measured, now the switch S3 is closed and the data voltage RD1 is supplied to the node N1 and thus summed to the threshold voltage stored in the capacitor C2. Consequently, the drive voltage at the gate of the transistor S2 is equal to the data voltage plus the threshold voltage and the correct current I will be generated. Next, the row select signal RS1 changes into a low level and also the transistor S1 stops conducting. The voltage on the capacitor C1 is kept until a next cycle. Further, the duty cycle signal DR changes to a high level such that the current I1 starts flowing through the light generating element PL1. At the end of the on-period T1, the duty cycle signal DR changes back to a low level and the current I1 stops flowing.

Alternatively, many other pixel drive circuits are possible.

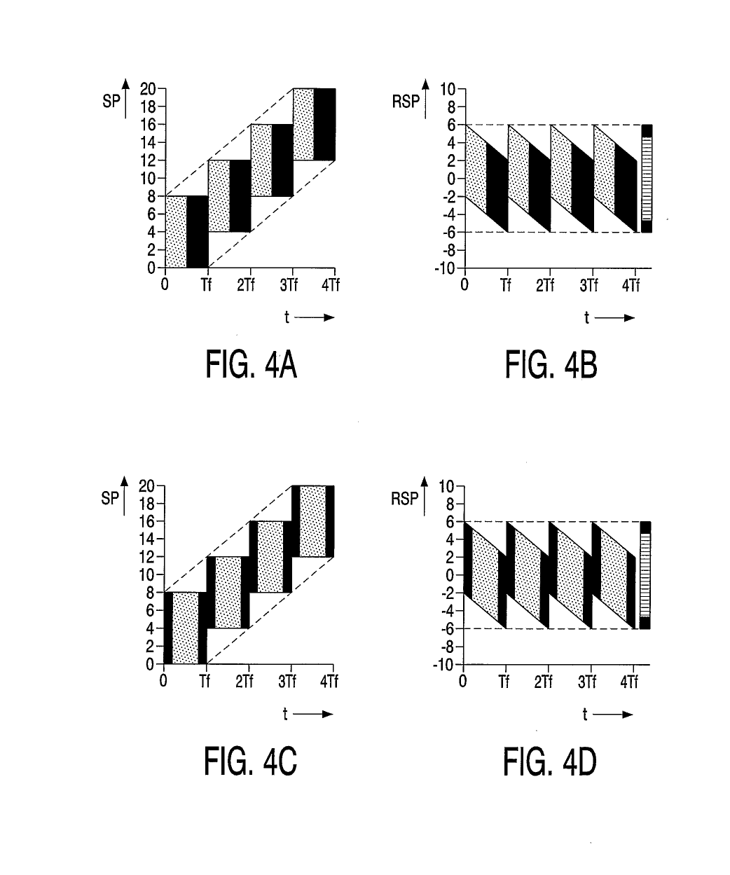

FIG. 4 elucidates the effect of centering the drive pulses with respect to the frame period. By way of example it is assumed that the matrix display comprises red, green and blue light emitting elements PL1, PL3, PL2, respectively. Further, by way of example, the duty cycle of the red and green light emitting elements PL1 and PL3 is 50% and the duty cycle of the blue light emitting element PL2 is 100%.

FIG. 4A shows the position SP of a moving white block on the screen in four successive frame periods Tf. The green and red contributions to the white block are displayed with a duty cycle of 50%, the blue contribution with a duty cycle of 100%. The white bar within the frame periods Tf indicates the on-time of the red and green light emitting elements PLi, the black bar in the frame periods Tf indicates the off-time of the red and green light emitting elements PLi. Although not visible, the black bars are actually blue because the blue light emitting element is active the complete frame period Tf. By way of example only, the white block is moving linearly in time.

FIG. 4B shows the viewers perception of the moving white block when his eyes are tracking the moving block. Now, the viewer projects the moving white block during each frame period Tf at the same position and their contributions are summed (integrated) by the eyes. The resulting integrated luminance is indicated by the right hand bar. White areas in this luminance bar have a high luminance, black areas a low luminance. However, due to the fact that the blue contribution is present during the complete frame period Tf while the red and green contributions are present during the first half of the frame period Tf only, the black area at the bottom of the bar is in fact bluish. Thus, a color break-up occurs. The vertical axis represents the repositioned screen position RSP.

FIG. 4C, again shows the position SP of the moving white block on the screen in four successive frame periods. This is the same situation as shown in FIG. 4A, but wherein the on-time of the red and green light emitting elements PL1 and PL3 are centered around the center of the frame periods Tf. Again, the blue light emitting element PL2 emits light during the complete frame period Tf. Consequently, now the white bar is centered around the center of the frame periods Tf.

FIG. 4D shows, as in FIG. 4B, the viewers perception of the moving white block when his eyes are tracking the moving block. Now, the viewer projects the moving white block during each frame period Tf at the same position and their contributions are summed (integrated) by the eyes. The resulting integrated luminance is indicated by the right hand bar. Now, the bluish part of the right hand bar is divided over the top and the bottom area of the right hand bar and becomes less visible. The vertical axis represents the repositioned screen position RSP.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1-13. (canceled)

14. A driver (DD, SD, PD1, PS1, PD2, PS2) for supplying, at a frame rate, a first current (I1) with a first duty cycle being smaller than 1 to a first light emitting element (PL1) of an active matrix display (AMD), and a second current (I2) with a second duty cycle to a second light emitting element (PL2) of the active matrix display (AMD), wherein the second light emitting element (PL2) has a shorter lifetime than the first light emitting element (PL1), and wherein the driver (DD, SD, PD1, PS1, PD2, PS2) is arranged for controlling the second duty cycle to be larger than the first duty cycle to increase the lifetime of the second light emitting element (PL2), and for controlling a maximum first current (ML1) to be larger than a maximum second current (ML2).

15. A driver (DD, SD, PD1, PS1, PD2, PS2) as claimed in claim 14, comprising a first pixel switching circuit (PS1) for only supplying the first current (I1) during a first time period (T1) within a frame period (Tf), and a second pixel switching circuit (PS2) for only supplying the second current (I2) during a second time period (T2) within the frame period (Tf), wherein a minimal duration of the second time period (T2) is longer than a minimal duration of the first time period (T1).

16. A driver as claimed in claim 14, wherein the first time period (T1) is selected to be equal or shorter than half the frame period (Ts), while the second time period (T2) is selected to be longer than half the frame period (Ts).

17. A driver as claimed in claim 14, wherein the second time period (T2) is selected to be substantially equal to the frame period (Tf) and wherein the first time period (T1) is selected to be shorter than half the frame period (Tf).

18. A driver as claimed in claim 15, wherein the first pixel switching circuit (PS1) and the second pixel switching circuit (PS2) are arranged for substantially centering the first time period (T1) and the second time period (T2) with respect to each other.

19. A driver as claimed in claim 15, wherein the driver (DD, SD, PD1, PS1, PD2, PS2) further comprises a first pixel driving circuit (PD1) for supplying the first current (I1) to the first pixel switching circuit (PS1), a level of the first current (I1) being determined by a first data signal (RD1), and a second pixel driving circuit (PD2) for supplying the second current (I2) to the second pixel switching circuit (PS2), a level of the second current (I2) being determined by a second data signal (BD1), the first time period (T1) and the second time period (T2) having predetermined fixed durations per frame period, dependent on an expected amount of motion blur per frame period.

20. A display module comprising an active matrix display (AMD) comprising a first light emitting element (PL1) and a second light emitting element (PL2), and the driver (DD, SD, PD1, PS1, PD2, PS2) as claimed in claim 14.

21. A display module as claimed in claim 20, wherein the first and the second light emitting elements (PL1, PL2) are organic light emitting diodes.

22. A display module as claimed in claim 21, wherein the first light emitting element (PL1) is arranged for emitting light having a first color, and the second light emitting element (PL2) is arranged for emitting light having a second color being different from the first color.

23. A display module as claimed in claim 22, wherein the first color is red and the second color is blue.

24. A display apparatus comprising the display module as claimed in claim 20.

25. A method of driving an active matrix display (AMD) comprising a first light emitting element (PL1) and a second light emitting element (PL2), the method comprising
supplying (DD, SD, PD1, PS1, PD2, PS2), at a frame rate, a first current (I1) with a first duty cycle being smaller than one to a first light emitting element (PL1) of an active matrix display (AMD), and a second current (I2) with a second duty cycle to a second light emitting element (PL2) of the active matrix display (AMD), wherein the second light emitting element (PL2) has a shorter lifetime than the first light emitting element (PL1),
the supplying (DD, SD, PD1, PS1, PD2, PS2) controlling the second duty cycle to be larger than the first duty cycle to increase the lifetime of the second light emitting element (PL2) and controlling a maximum first current (ML1) to be larger than a maximum second current (ML2).

26. A method of driving an active matrix display as claimed in claim 25, wherein the supplying (DD, SD, PD1, PS1, PD2, PS2) comprises
supplying (PD1) the first current (I1) having a level being determined by a first data signal (RD1), and
supplying (PD2) the second current (I2) having a level being determined by a second data signal (BD1),
supplying (PS1) the first current (I1) to the first light emitting element (PL1) during a first time period (T1) within a frame period (Tf) only, and
supplying (PS2) the second current (I2) to the second light emitting element (PL2) during a second time period (T2) within the frame period (Tf) only, the first time period (T1) and the second time period (T2) having predetermined fixed durations, a minimal duration of the second time period (T2) being longer than a minimal duration of the first time period (T1).
